(19) United States
(12) Patent Application Publication
(10) Pub. No.: US 2012/0320594 A1
(43) Pub. Date: Dec. 20, 2012

(54) LIGHT DEVICE WITH DISPLAY MEANS HAS TRACK-MEANS AND REMOVABLE LED-UNITS

(76) Inventor: Tseng-Lu CHIEN, Walnut, CA (US)

(21) Appl. No.: 13/162,824

(22) Filed: Jun. 17, 2011

(51) Int. Cl. F21V 21/14

(52) U.S. Cl. 362/249.03

(57) ABSTRACT

The light device with display means has track-means and removable LED-unit(s) which disclosure to apply the display means for inner track-means and LED-unit(s) so can make the light device with value appearance. The features to use track-means and Removable LED-unit(s) which can replace, change, add or reduce the number of the LED-unit(s) instantly to come out different cost, brightness, color, viewing angle, different location for Illumination, different emit directions of light beam, functions, effects just simple to remove the said LED-unit(s) within the track-means. Furthermore, track-means may in multiple-surface construction so can has multiple track-means to install desire LED-unit(s) with desired length of track-means and width of the each LED-unit(s) can come out variety different light device in seconds because all LED-unit(s) can be removable, change position, add or reduce the number of the LED-unit(s) so this is big improvement for all light device(s) at conventional market applications.

### BACKGROUND

(LED Has Changeable Position Feature)

The current invention is Continuously filing from co-pending filing for U.S. Ser. No. 11/806,285 for LED bulb and U.S. Ser. No. 12/003,809 & U.S. Ser. Nos. 12/073,889 & 12/894,865 for LED light device has change position features.

The current invention for The LED track light variety application which are apply the co-inventor's issued patent U.S. Pat. No. 7,618,150, U.S. Pat. No. 7,726,869, U.S. Pat. No. 7,722,230 for LED track light or removable LED-units on track-means for variety application including for as below details description and co-inventor above discussed issued patent and prior filing cases with its background, drawing, detail description, claims should all fall within the current invention for the LED track light or Removable LED-unit(s) on track-means.

From above listed U.S. Pat. No. 7,618,150 and U.S. Pat. No. 7,726,869 has very clear definition the LED track light has removable LED-unit(s) on the track-means(s) with resilient conductive means to contact with the said electric signal so can change to any desire position while outside force applied. The said LED-unit(s) can replace, assembly, disassembly from the ends of the said track-means. The said LED-unit(s) can has desire number of LED-means for preferred specification, brightness, size, dimension, color, functions, performance, effects under predetermined requirement. It also can has any geometric shape track-means as long as allow the said LED-unit(s) been removable within the track-means. The track-means also can has at least one track-means on one products.

Hereof, The current invention disclosure the variety of applications for the said LED track light as above listed prior issued patents and prior co-pending filing cases for above listed more than (1) to (10) application so can use simple LED track light construction to create plurality of different lighting for people to use to save a lot of cost for tooling, PCB, Labor, resource to make such plurality of lighting products.

The LED track light has track-means preferred to use extrusion process to make the desired construction such as track-means has at least one track to install the LED-unit(s). However, It also can make more than 1 track-means on the desired location such as 2 or it can make one extrusion tooling has hexagon construction which has 6 track-means on each surface so can have LED-unit(s) emit light beam to 6 directions. Furthermore the extrusion tooling also can be design of octagon construction and has 8 surface face outward and arrange at least 8 LED-unit(s) within the 8 track-means to allow LED-unit(s) emit the light been up to 8 directions.

It is appreciated, the multiple-surface(s) of the Track-means can be made by the conventional skill and technical from different material or procedure to get same function or equivalent features with alternative or improvement of the LED track light concept discussed as all prior issued patents, pending patents still fall within the current invention scopes.

The LED track-means tooling is very simple and cost is very cheap, which will allow people to make the said all different application LED lighting fixture, LED bulb, LED lighting for all purpose become simple. Especially, the each Track-means can load different number of the said LED-unit(s) so each track-means with different number of LED-unit(s) will come out Big Range of the cost difference. Normally, Less LED-unit(s) will have lower cost. More LED-unit(s) will increase the cost. Hence, Just simple use the LED-unit(s) number can meet all different buyers satisfactory.

Other features is each track-means has 1 to N (any number) of surface so it is easily to design the LED light device for certain purpose such as Corner light can use “L” shape track-means so the LED-unit(s) light beam only emit to two direction and no light emit to corner to save a lot of power consumption. For example the down light for office or production line use, It can design for 1 track-means face down so there has no light to emit to top or side position to save the power consumption again than the current market use for Fluorescent tube or incandescent bulb which has too many Light beam waste to non-necessary areas for illumination. These power consumption have to be made by (1) narrow viewing angle of LED-means (2) low cost substrate to arrange variety of LED-means→However, the best will be use track-means. (3) the removable LED-unit(s) with resilient conduct means to build the electric signal contact at any time at any location will be the fatal requirement. (4) Perfect design for preferred geometric shape and dimension for track-means and LED-unit(s) so can fit for different requirement such as the LED bulb need super small track-means in hexagon or octagon shape with tiny removable LED-unit(s) which LED-units can has LED-means from Number 1 to Number (N) to meet quickly production or cost consideration. However, for the FLOOR light, it will need bigger dimension of track-means and LED-unit(s) so can has 2 inch for LED bulb, 3 inch for LED bulb, 2 feet for desk lamp, 3 feet for floor lamp or LED florescent tube , 4 feet for the under cabinet light, 6 feet or more for working down light.

(LED Bulb and LED-Flo-Tube)

The current invention also teach the method how to make the LED-bulb to replace the all kind of market available incandescent bulb with copper base, it is simple just make the super compact size of the said track-means and LED-unit(s).

It also teach how to use the elongate or tubular track-means and LED-unit(s) to make same size of all conventional real florescent tube and replace it because the lower const while apply the current invention one extrusion hexagon or octagon track-means with 6 or 8 or more surfaces can load LED-units to emit the light to multiple directions.

Furthermore, the same multiple-surface(s) extrusion track-mean has multiple track-mean number on the extrusion unit. The extrusion can make super long length and just need to cut into desire length such as 1 feet, 2 feet, 3 feet, 4 feet, 5 feet, up to 10 feet or longer so can easily to put into outside housing, cover, lens to make the sufficient long to make identify same length of the existing florescent tube length including the two ends contact terminals so can easily fit into the existing all florescent tube housing, base, frame, holder and incorporated the proper circuit means to match the two ends contact terminals' output current signal and change to the current signal to drive the said LED-units or LED-means for desired illumination under predetermined functions, effects, performance etc. The multiple surface extrusion unit has multiple track-means so can install desired LED-unit(s) on desire location to make the LED-Flo-Tube to emit the light beam to specified area(s) such as only the down area which around 60 degree arc of the circle of the said diameter of the said LED-Flo-Tube and rest of 300 degree of the said circle of the said tube's diameter away from the down location will be has no light emit so the limited area illumination for the said LED-Flo-tube can save a lot of power consumption than traditional of the Florescent tube did.

It is also appreciated that each LED-unit(s) for the LED-Flo-Tube may has ⅕ of the length of the super long length of the said LED-Flo-Tube length. This will be much much easier to make ⅕ of length of LED-unit(s) than make whole length of 1/1 of tube length which used by current market people. So, Each track-means only need to install 4 pcs or 3 pcs or 2 pcs or 1pcs of the LED-unit(s) into the each super long length so can keep the LED-unit(s) still removable. Hence, the more longer track-means can has more longer LED-unit(s) to save labor, time, cost, material, assembly time, troubles which happened on existing other LED tube light. This is great improvement to make LED-FLO-Tube by (1) Arc of the circle with illumination to save power consumption (2) Use longer LED-unit(s) to reduce the assembly time to put LED-unit(s) into track-means by longer LED-unit(s) (3) prefer to use extrusion unit has multiple surface(s) track-means to allow can arrange best light emitting directions as wish (4) selected track-means has LED-units and rest of track-means do not install LED-units or use limited number of LED-unit(s) to make low-cost unit to meet some customer required low-cost without to change the extrusion unit as the main construction frame, substrate to save cost , time, labor to redesign all different cost and specification LED-FLO-Tube.

Compare with all prior art for the said LED-Bulb such as the US prior art for the LED Bulb such as U.S. Pat. No. 5,924,784 Chliwnyj et al and U.S. Pat. No. 6,220,722 Begemann and U.S. Pat. No. 6,499,860 and U.S. Pat. No. 7,254,089. These prior arts are fail to disclosure to use any of the said track-means and removable LED-unit(s) to arrange the said plurality of LED for the said LED bulb. The current invention use a simple preferred procedure to extrusion the track-means for more than one surface(s) and arrange the desire number of LED-unit(s) within the multiple track-mean(s) on the multiple surface(s) of the said extrusion single piece so can make the desire number of LED(s) on the desired number of removable LED-unit(s) to fit into the desired number of the track-mean(s) to desired number of the multiple-surface(s). Whenever need to change the brightness, color, cost, photometric, It is simple just change the LED-unit(s) with desired LED(s) specification and number can meet market different requirement in short time without to make a lot of PCB and install LED on the new PCB and make all heavy labor intensity. Hence, the current invention for the LED bulb has big improvement than ever.

The current invention for LED bulb also is continuously filing of co-pending filing of U.S. Ser. No. 11/806,285 FIG. 13 claim 12 dated on claim revised on Mar. 23, 2011, it is appreciated the current invention apply the track-means and removable LED-units will still fall within the both prior co-pending case and current discussion of the concept.

(Light Device Has Geometric Art Image on Surfaces)

The current invention also is the continuously filing for U.S. Ser. No. 12/622,000 has the same FIG. 8,9,10 on the page 6 and page 7 and the claim 19 and claim 20 which are has certain block mean(s), cutouts, openings, windows, optics means, light passing though medium, reflective means to allow LED light beam travel within the light passing though medium and multiple reflective means and right LED position to create the geometric art for the said Light Device by LED and track-means and LED-units on desired orientation, position, location in x-y-z axis.

The features of the current invention for LIGHT DEVICE with Display Means has track-means and removable LED-units made big improvement to prevent people to spend money, time, labor, resource to make any incoming new requirement for different specification light device. The current light device can let consumer to make its own light device with preferred LEDs on certain location because removable LED-unit can change position. It also can add or reduce the said LED-unit(s) to become different light brightness and cost. It also can add or reduce or replace the LED-unit(s) to get colorful, multiple color, certain area(s) has light emit to for illumination by consumer. Hence, this universal and customized production can make by consumer basing on track-means and removable LED-unit(s) and with preferred shade, cover, housing, decorative means may selected by consumer from home place to change it up to each person's preferred. Hence, the current invention for Light Device with Display means has track-means and removable LED-unit(s) is perfect idea.

It is appreciated any alternative, improvement, same function, equivalent features, revised components still fall within the current invention scope including all above discussed of co-inventor's co-pending, patented patents content, drawing, description, claims.

### DRAWING

FIG. 1: Disclosure the LED bulb with display means (here is the bulb glass or plastic lens) has more than 10 track-means and 10 removable LED-unit(s) fill inside the track means. The said LED-unit(s) can has any number of the LED-means (LEDs) for different light brightness, color, functions, effects. The preferred embodiment is add 8 LEDs on each LED-unit(s) and LED-unit length is almost same length with track-means. The Top end has one more LED-unit which is not removable to offer the light to top area of said LED bulb.

FIG. 2: Disclosure the other alternative LED bulb which has 8 LED-means (8 LEDs) on each removable LED-unit(s) which fit within the 6 hexagon extrusion track-means, the said LED-means are arrange on 2 rows×4 pcs/each row=8 LEDs on each LED-unit and emit the light beam to 6 directions. The top also has one more LED-unit which is non-removable and stay on position by some fix-means.

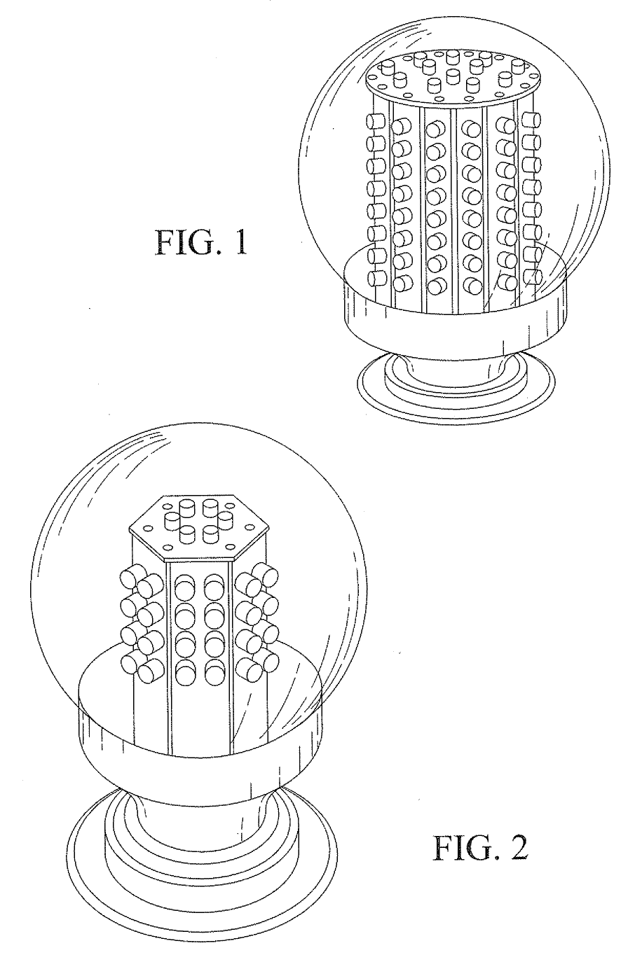

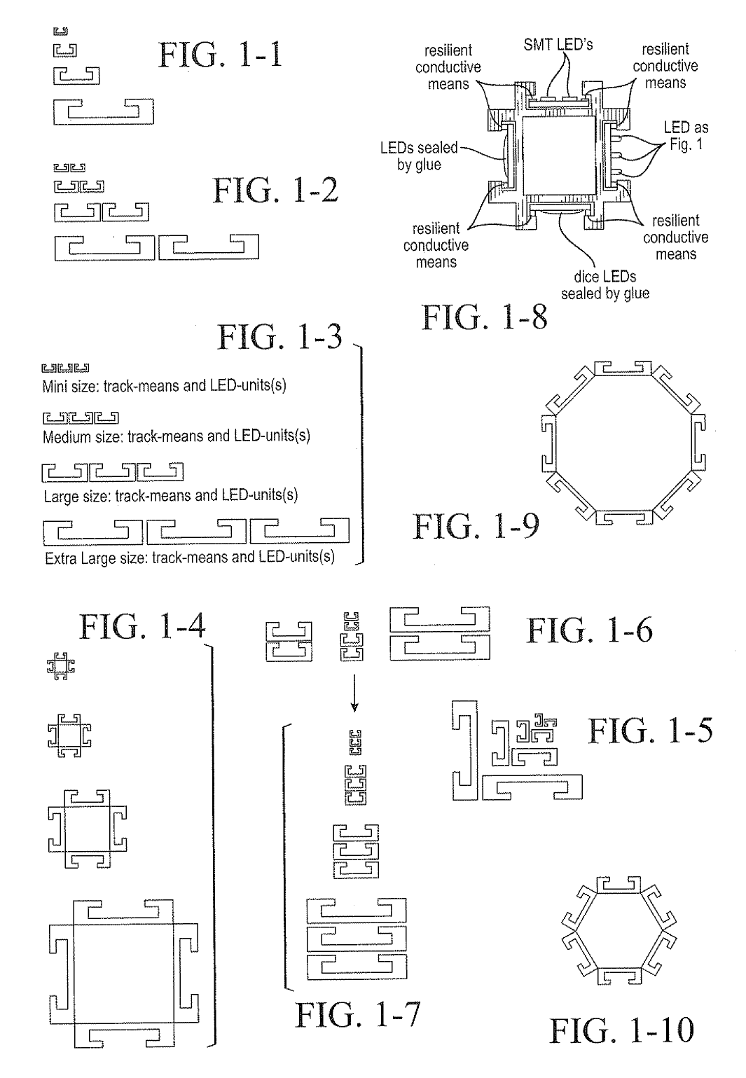

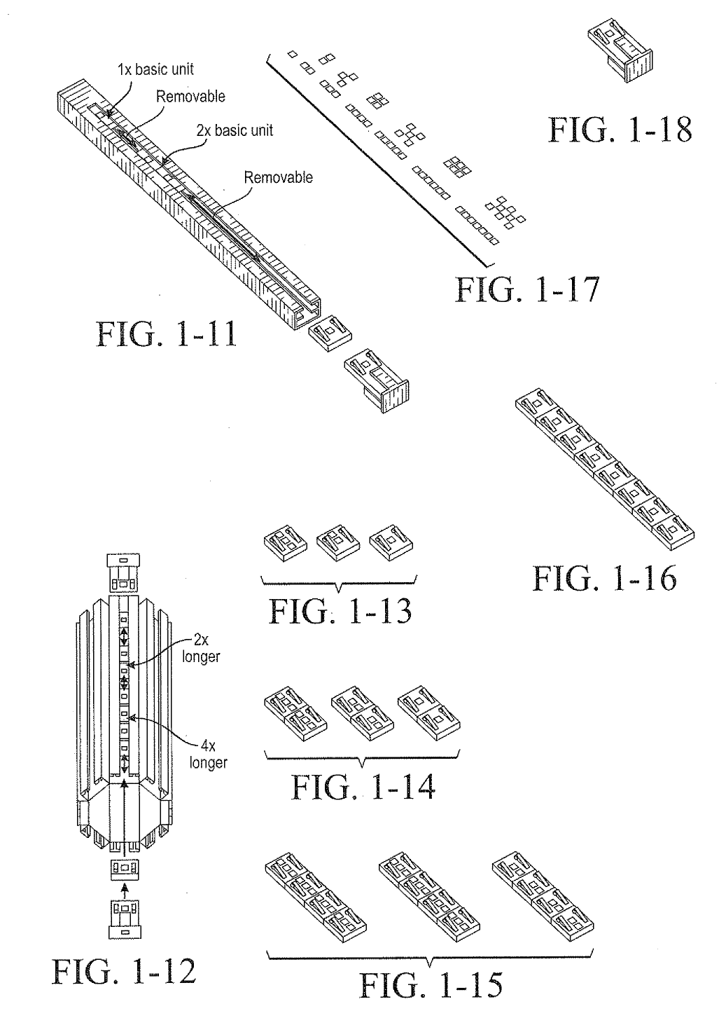

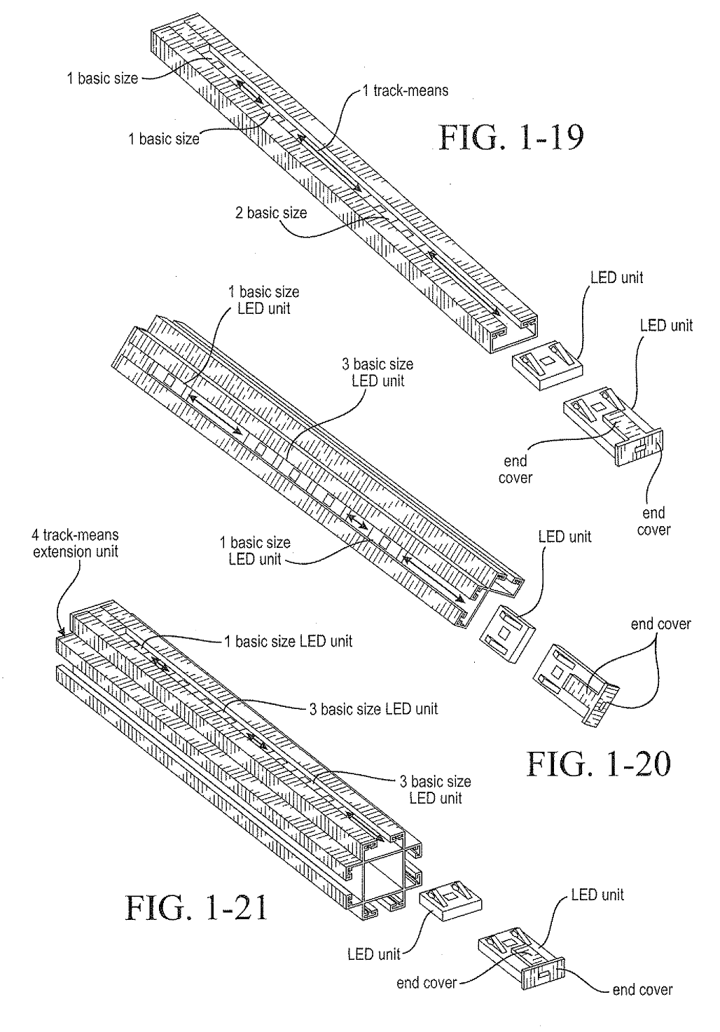

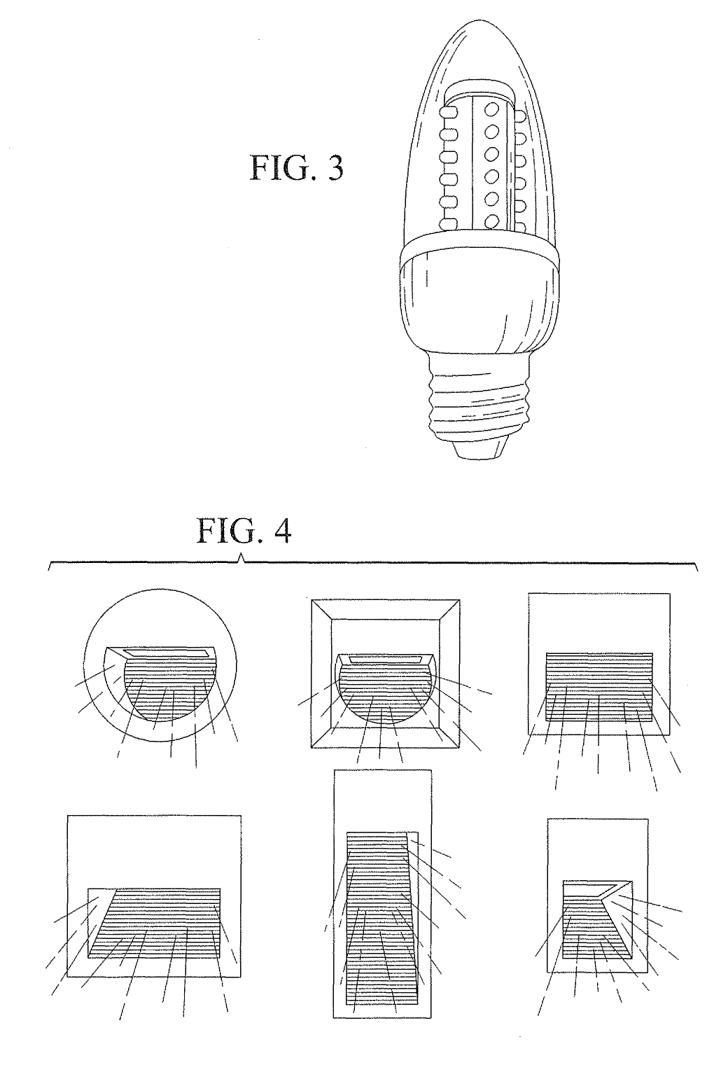

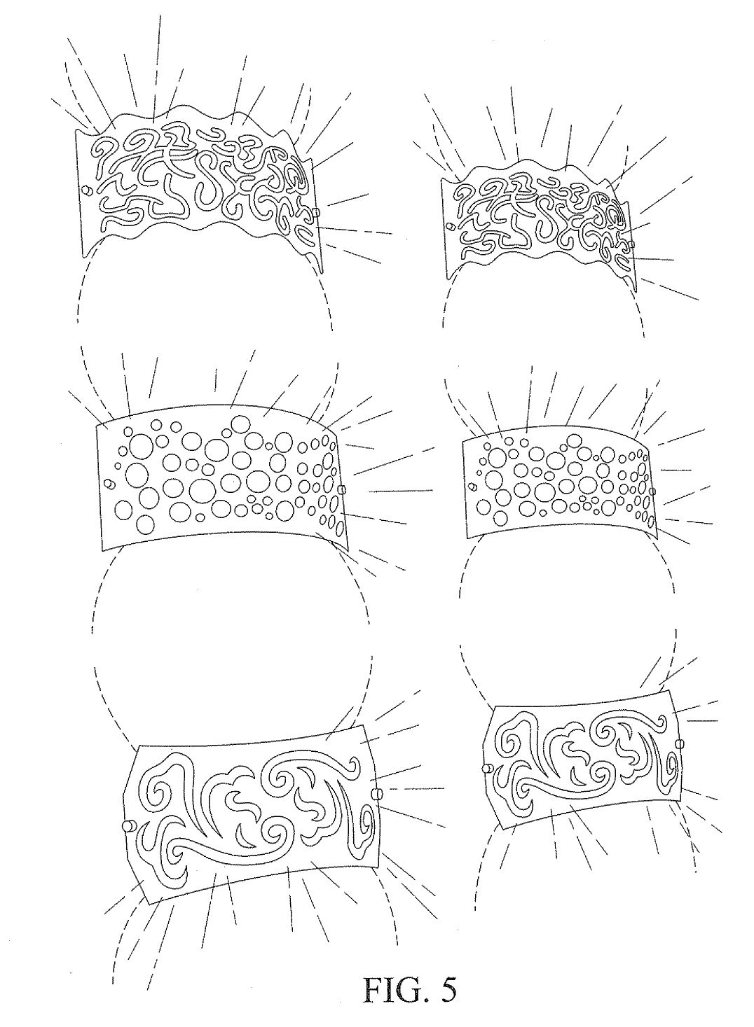

FIGS. 1-1 to 1-21: Disclosure the details description of the said extrusion unit, track-means, LED-unit, LED-means (LEDs) relation, design, alternative design, upgrade models and possibility of the application for inner parts of the said Display means. The said track-means, LED-unit(s), LED-means are incorporate with Display means so can has value appearance. The current invention preferred to use extrusion Method to make the track-means with number of surface(s) so can has same number of track-means to load the relatively LED-unit(s) to make the desire illumination on perfect location of said light device. The different track-means from single track-means, 2 track-means in parallel or in certain degree, 3 track-means on parallel, 4 track-means for “□” square or rectangular arrangement, 6 track-means in hexagon arrangement, 8 track-means in octagon arrangement will offer the illumination from 10 degree up to 360 degree along the said x-y-z axis. More details description as the drawing notes for quickly understand all possibility, all preferred arrangement however all these illustration, drawing, notes and all the alternative or equivalent function or same effects or revised design still fall within all the current discussion and it is appreciated all prior art of co-inventor patents or pending patent's concept also fall within the current invention scope.

FIG. 3: Disclosure the LED bulb with display-means which is a bulb glass cover and has the 4 track-means and each track means has 6 piece LED-means so come out one LED bulb with 24 pieces LEDs face outward cover 360 degree and top has other LED means arrangement. The said LED bulb has all different shape and base same as all the conventional incandescent bulb for variety different shape and base. The current invention use the mini size of track-means and removable LED-units to fit within all kind of the incandescent bulb size and bases so can change all the said incandescent bulb into LED bulb. Further more the current invention apply the same technical for the conventional florescent tube to make the LED-FLO-Tube which has LED means on the said removable LED-unit(s) to fit within at least one of the track-means of the said LED-FLO-tube with proper two ends and circuit means to directly to use the existing Florescent tube electric current to turn on and Turn off LED as wish. However, it is also same technical and make a new LED-Flo-tube which has its own Circuit which the light device DO NOT HAVE OLD Florescent tube starter system so can has more simple circuit without need to work with existing florescent tube starter system so it is 100% for current invention isolated items nothing to do with existing florescent tube starter circuit.

FIG. 4: Disclosure the cover, shade, housing, optics lens, block means, stencil, cutout, opening, windows, holes for the inner LED track-means and LED-unit(s) and LED means. The FIG. 4 disclosure all kind of Wall light which can apply to the drive way, theater, home, outdoor on wall, surface for offer floor with illumination and cosmetic for dark areas. It can make by any material as above discussed.

FIG. 5 Disclosure the Wall light application again. Same as FIG. 4 feature but the inner track-means and LED-unit(s) and LED-means are not visible from the front because it may add one milky diffuser lens which belongs to optics means of the notes on the all Figures and illustrations. As Notes on the FIG. 5 has all details how the material and cover can be made out. Please check notes of FIG. 5. Again, the inner side has the track-means and LED-units and LED-means of the said Light device with display means.

FIG. 6: Disclosure the wall light with reading light applications. The display means is made by all kind material as the notes on the illustration. Again, the inner side has the track-means and LED-units and LED-means of the said Light device with display means.

FIG. 7 and FIG. 8 and FIG. 12: Disclosure the wall light the display means may select from group combination from optics means, lens, reflector, diffuser lens, filter, light passing though medium, reflective means, or any other related to the Optics parts & accessories, cover, housing, shade, decorative means, cutouts, stencil, windows, openings or may selected from the market available place. The wall light has light image by the optics means not only as the FIG. 7 and FIG. 8, But it also show on the FIG. 12 for geometric art image shown on surface(s), wall(s), Floor(s) by other arrangement for all optics means, light passing though means, reflective means etc. Again, the inner side has the track-means and LED-units and LED-means of the said Light device with display means.

FIG. 9: Disclosure other wall light applications same as detail notes on illustration. This illustration and notes mainly for the light beam may design for 360 degree emit outward to the cover, housing, shade with cut-outs, openings, windows, stencils, printing, gaps, rings to has plurality areas on the body can be seen the light beams. Again, the inner side has the track-means and LED-units and LED-means of the said Light device with display means.

FIG. 10: Disclosure the special purpose light application has bubbles decorative means to cover the inner track-means and LED-units. The notes has more details.

FIG. 11: Disclosure the floor light which has whole length or partial length along the has LED-units inside. The inner track-means may for more than 3 surface(s) so can cover 360 degree illumination. The shade, cover, housing can use paper, plastic, bamboo, foldable material, see though means, opaque means, translucent means, to get desire illumination for indoor or outdoor use. The notes on the figure also has other features.

FIG. 12: Disclosure the light device has geometric art image shown on surface(s), Floor, walls. It may use high power LED-mean on center location and arrange light beam passing though light traveling medium and reflective means to allow the light spread out to the outer stencil, printing, cutouts, openings, windows, silkscreen, blockmeans to show some geometric arts on the surface(s), wall(s), Floor(s) to be seen. This is same technical as co-inventor prior invention and pending filing. The notes show all the prior co-pending case data.

### DETAIL DESCRIPTION

From FIG. 1: Disclosure the LED bulb with display means (here is the bulb glass or plastic lens) has more than 10 track-means and 10 removable LED-unit(s) fill inside the track means. The said LED-unit(s) can has any number of the LED-means (LEDs) for different light brightness, color, functions, effects. The preferred embodiment is add 8 LEDs on each LED-unit(s) and LED-unit length is almost same length with track-means. The Top end has one more LED-unit which is not removable to offer the light to top area of said LED bulb.

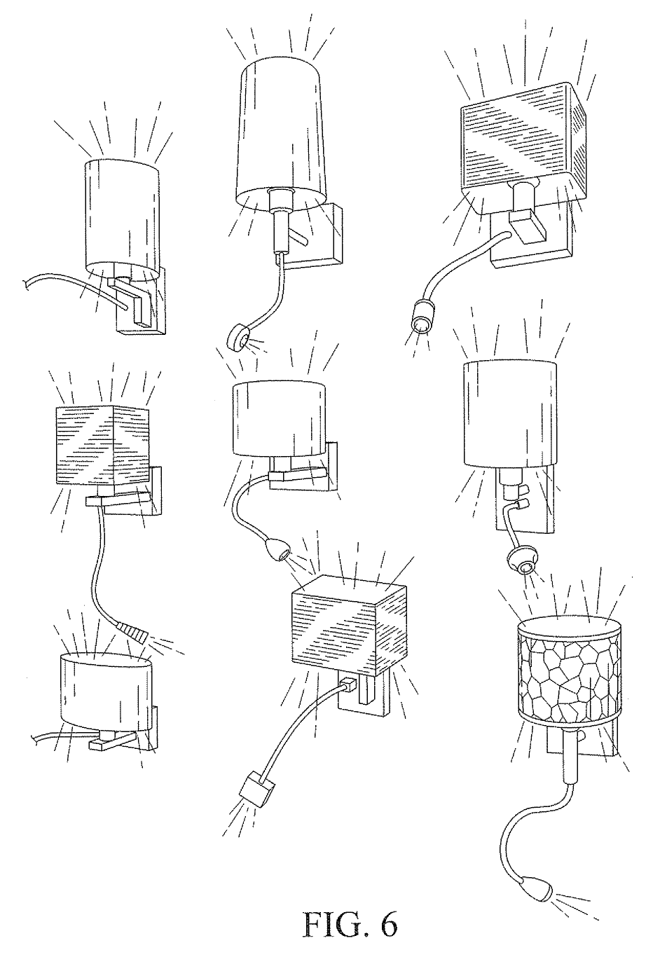

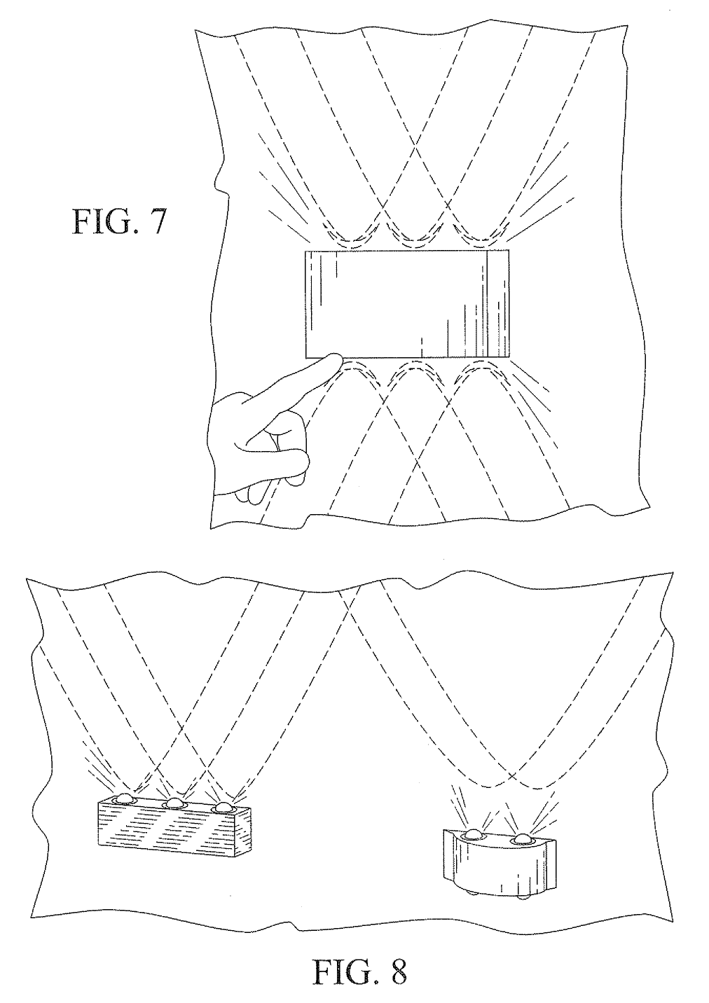

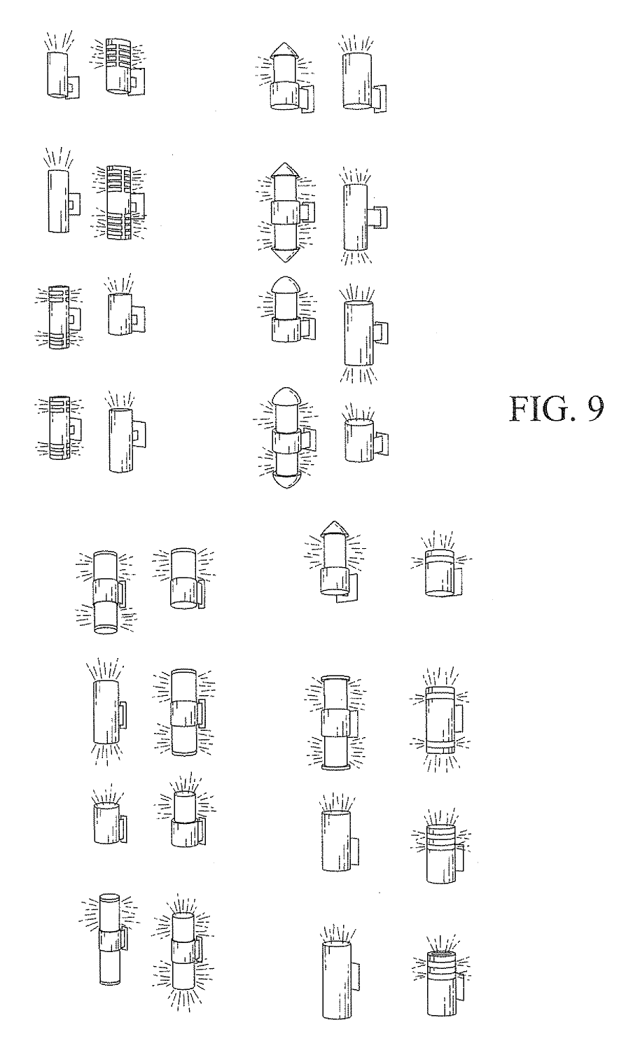

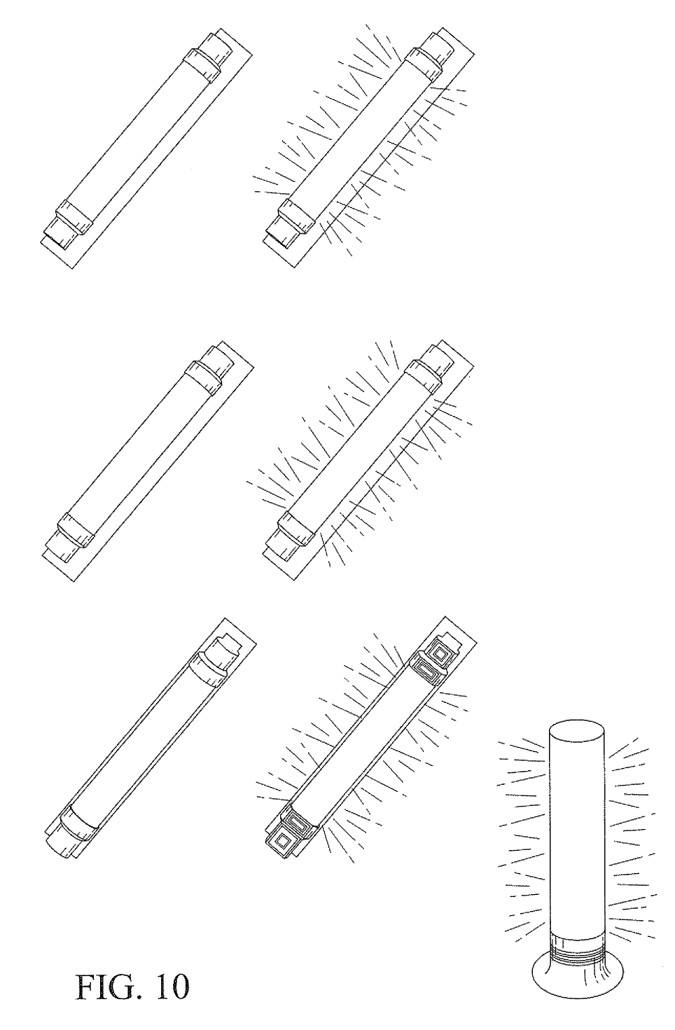

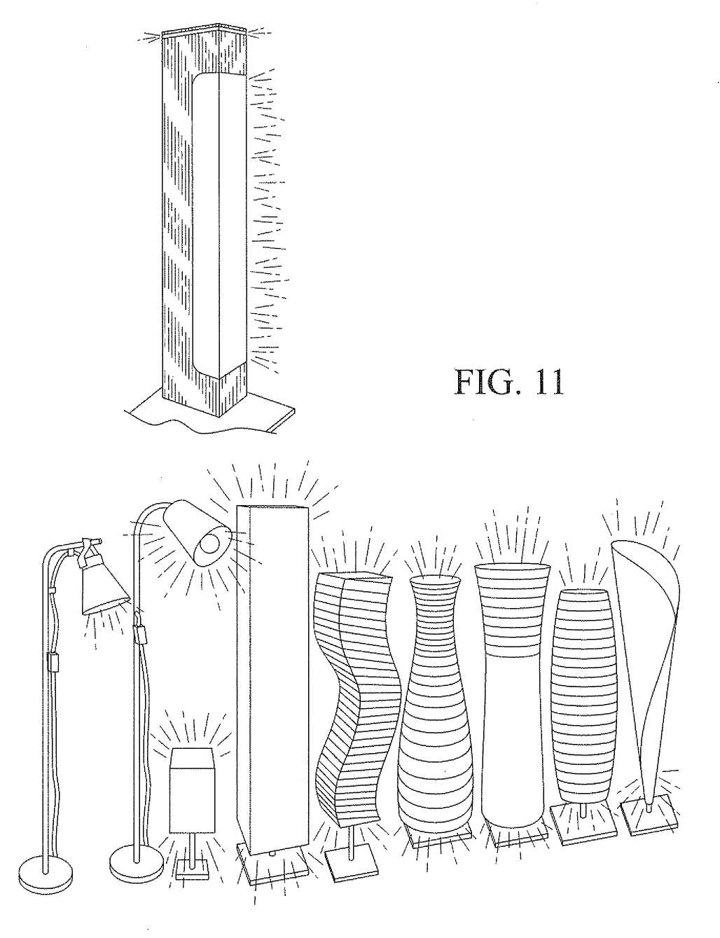

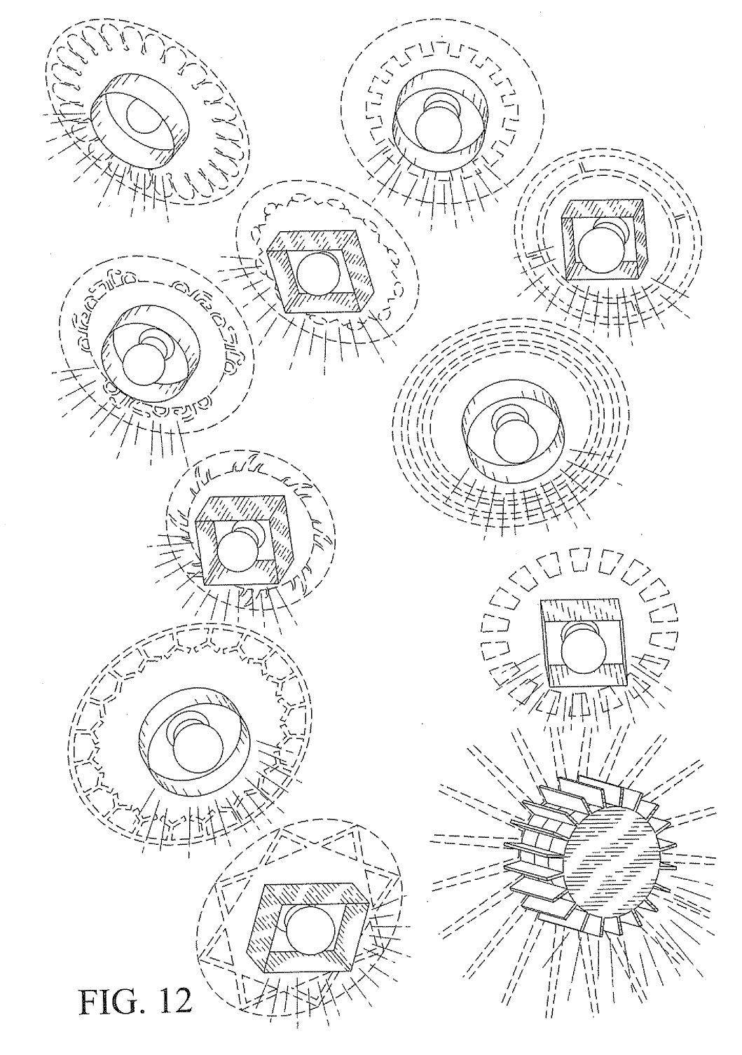

From FIG. 2: Disclosure the other alternative LED bulb which has 8 LED-means (8 LEDs) on each removable LED-unit(s) which fit within the 6 hexagon extrusion track-means, the said LED-means are arrange on 2 rows×4 pcs/each row=8 LEDs on each LED-unit and emit the light beam to 6 directions. The top also has one more LED-unit which is non-removable and stay on position by some fix-means.

From FIGS. 1-1 to 1-21: Disclosure the details description of the said extrusion unit, track-means, LED-unit, LED-means (LEDs) relation, design, alternative design, upgrade models and possibility of the application for inner parts of the said Display means. The said track-means, LED-unit(s), LED-means are incorporate with Display means so can has value appearance. The current invention preferred to use extrusion Method to make the track-means with number of surface(s) so can has same number of track-means to load the relatively LED-unit(s) to make the desire illumination on perfect location of said light device. The different track-means from single track-means, 2 track-means in parallel or in certain degree, 3 track-means on parallel, 4 track-means for “□” square or rectangular arrangement, 6 track-means in hexagon arrangement, 8 track-means in octagon arrangement will offer the illumination from 10 degree up to 360 degree along the said x-y-z axis. More details description as the drawing notes for quickly understand all possibility, all preferred arrangement however all these illustration, drawing, notes and all the alternative or equivalent function or same effects or revised design still fall within all the current discussion and it is appreciated all prior art of co-inventor patents or pending patent's concept also fall within the current invention scope.

From FIG. 3: Disclosure the LED bulb with display-means which is a bulb glass cover and has the 4 track-means and each track means has 6 piece LED-means so come out one LED bulb with 24 pieces LEDs face outward cover 360 degree and top has other LED means arrangement. The said LED bulb has all different shape and base same as all the conventional incandescent bulb for variety different shape and base. The current invention use the mini size of track-means and removable LED-units to fit within all kind of the incandescent bulb size and bases so can change all the said incandescent bulb into LED bulb. Further more the current invention apply the same technical for the conventional florescent tube to make the LED-FLO-Tube which has LED means on the said removable LED-unit(s) to fit within at least one of the track-means of the said LED-FLO-tube with proper two ends and circuit means to directly to use the existing Florescent tube electric current to turn on and Turn off LED as wish.

However, it is also same technical and make a new LED-Flo-tube which has its own Circuit which the light device DO NOT HAVE OLD Florescent tube starter system so can has more simple circuit without need to work with existing florescent tube starter system so it is 100% for current invention isolated items nothing to do with existing florescent tube starter circuit.

From FIG. 4: Disclosure the cover, shade, housing, optics lens, block means, stencil, cutout, opening, windows, holes for the inner LED track-means and LED-unit(s) and LED means. The FIG. 4 disclosure all kind of Wall light which can apply to the drive way, theater, home, outdoor on wall, surface for offer floor with illumination and cosmetic for dark areas. It can make by any material as above discussed.

From FIG. 5 Disclosure the Wall light application again. Same as FIG. 4 feature but the inner track-means and LED-unit(s) and LED-means are not visible from the front because it may add one milky diffuser lens which belongs to optics means of the notes on the all Figures and illustrations. As Notes on the FIG. 5 has all details how the material and cover can be made out. Please check notes of FIG. 5. Again, the inner side has the track-means and LED-units and LED-means of the said Light device with display means.

From FIG. 6: Disclosure the wall light with reading light applications. The display means is made by all kind material as the notes on the illustration. Again, the inner side has the track-means and LED-units and LED-means of the said Light device with display means.

From FIG. 7 and FIG. 8 and FIG. 12: Disclosure the wall light the display means may select from group combination from optics means, lens, reflector, diffuser lens, filter, light passing though medium, reflective means, or any other related to the Optics parts & accessories, cover, housing, shade, decorative means, cutouts, stencil, windows, openings or may selected from the market available place. The wall light has light image by the optics means not only as the FIG. 7 and FIG. 8, But it also show on the FIG. 12 for geometric art image shown on surface(s), wall(s), Floor(s) by other arrangement for all optics means, light passing though means, reflective means etc. Again, the inner side has the track-means and LED-units and LED-means of the said Light device with display means.

From FIG. 9: Disclosure other wall light applications same as detail notes on illustration. This illustration and notes mainly for the light beam may design for 360 degree emit outward to the cover, housing, shade with cut-outs, openings, windows, stencils, printing, gaps, rings to has plurality areas on the body can be seen the light beams. Again, the inner side has the track-means and LED-units and LED-means of the said Light device with display means.

From FIG. 10: Disclosure the special purpose light application has bubbles decorative means to cover the inner track-means and LED-units. The notes has more details.

Again, the inner side has the track-means and LED-units and LED-means of the said Light device with display means.

From FIG. 11: Disclosure the floor light which has whole length or partial length along the has LED-units inside. The inner track-means may for more than 3 surface(s) so can cover 360 degree illumination. The shade, cover, housing can use paper, plastic, bamboo, foldable material, see though means, opaque means, translucent means, to get desire illumination for indoor or outdoor use. The notes on the figure also has other features. Again, the inner side has the track-means and LED-units and LED-means of the said Light device with display means.

From FIG. 12: Disclosure the light device has geometric art image shown on surface(s), Floor, walls. It may use high power LED-mean on center location and arrange light beam passing though light traveling medium and reflective means to allow the light spread out to the outer stencil, printing, cutouts, openings, windows, silkscreen, blockmeans to show some geometric arts on the surface(s), wall(s), Floor(s) to be seen. This is same technical as co-inventor prior invention and pending filing. The notes show all the prior co-pending case data. Again, the inner side has the track-means and LED-units and LED-means of the said Light device with display means.

It is appreciated the current inventions has following features as above 29 points.

1. The light device with display means has track-means and removable LED-unit(s) consist of;

At least one track-mean(s) and removable LED-unit(s) has at least one of LED-means to arrange on the said removable LED-unit(s).

The LED-unit(s) has desire light beam output to viewer while the electrodes of the said LED-unit(s) connect to the electric signal though any combination of the resilient conduct means, contact means, conductive means, circuit means, buss means, wire means, adaptor means, transformer means, inverter means, IC means, inductor means, electric parts & accessories, outlet means from the desire power source including Alternative current (AC) or the Direct current (DC) which may come from wall outlets, generator, solar power, batteries, wind power, chemical power or any power form available from conventional market place.

The said LED-unit(s) has removable functions and connect with the buss means all the time while travel within the said track-means by the resilient conductive means.

The said buss-mean supply the electric signal to the electrodes of the said LED-unit(s) from the circuit means, related electric parts & accessories, the said power source so can turn on the said LED-means on the LED-unit(s) for desired light outputs, color, brightness, functions, features, performance.

The said display means the said light device which is a finish product has the display parts & accessories to incorporate the said track-means and removable LED-unit(s) which the display parts & accessories may select from group combination including cover, lens, optics means, reflective lens, diffuser, filter lens, block means, stencil, cutouts, windows, openings, geometric art means, hologram means, lenticular means, 3D film, housing, shade, decorated parts & accessories made by plastic, wood, bamboo, paper, textile, garment, clothing, metal, pottery, ceramic, glass, chemical compound, crystal, mineral material, recycle material with the attachment means, frame means, holder means, fix means, glue means, clipper means, installation means, extendable means, transformer means, foldable means to add such the said display parts & accessories to the said track-means to become finish products has its function including (1) LED Desk Lamp (2) LED Wall lamp (3) LED Floor lamp (4) LED Under cabinet light (5) LED brick light (6) LED step light (7) LED parking light (8) LED light fixture (9) conventional any LED light(s) (10) LED bulb which has at least one of the said track-mean(s) and removable LED-unit(s), (11) LED-florescent tube (12) extendable light bar (13) LED light has geometric art image on surface, floor, walls (14)

2. The light device with display means has track-means and removable LED-unit(s), the said track-means which has different size to fit into certain space from 1 centimeter (0.4 inch) up to multiple meter (tens of feet).

3. The light device with display means has track-means and removable LED-unit(s), the said light device has at least one of the track-means which has at least one of the LED-unit(s) to fit within the said track-means.

4. The light device with display means has track-means and removable LED-unit(s) as, the said display means has at least partial in front of the said of LED-means or LED-unit(s).

5. The light device with display means has track-means and removable LED-unit(s), the said display means has its geometric size and dimension in x-y-z axis.

6. The light device with display means has track-means and removable LED-unit(s), the said track-mean(s) has positive ratio to the LED-unit(s) means. While bigger track-means(s) will have bigger LED-unit(s) means.

7. The light device with display means has track-means and removable LED-unit(s), the said each track-mean(s) has at least one of LED-unit(s) within the length of the track-mean.

8. The light device with display means has track-means and removable LED-unit(s), the said LED-unit(s) length and track-mean length can be from 1 to 1,000 to 1 to 0.99 to allow track-means can has at least one LED-unit up to 1,000 piece of LED-units.

9. The light device with display means has track-means and removable LED-unit(s), the said each LED-unit(s) has at least one LED-means up to 1,000 piece of LED-means with proper electric signal to drive the said LED-means for pre-determined functions, effects, performance.

10. The light device with display means has track-means and removable LED-unit(s), the said LED-means is one of specification which can get from conventional market available type.

11. The light device with display means has track-means and removable LED-unit(s), the said LED-unit(s) has desire color assortment, brightness, emit directions, optics means to get desired functions, effects.

12. The light device with display means has track-means and removable LED-unit(s), the said light device has display means to hide the track-means but allow light beam to be seen.

13. The light device with display means has track-means and removable LED-unit(s), the said display means is desire combination select from block means, stencil, cutouts, opening, masking to make the said LED light beam passing though and make a geometric art image on the surface(s), floor, Walls.

14. The light device with display means has track-means and removable LED-unit(s), the said track-means and LED-unit(s) are sealed within the extendable means so can make the light device has total length adjustable from desire maximum length to the shortest length to fit for different space, room, walls distance for illumination.

15. The light device with display means has track-means and removable LED-unit(s), the said geometric art means which consist of the said block means, printing means, stencil means, light passing medium, reflective means to make LED light beam travel within the light passing medium, or at least one or more reflect means to get the geometric art image to be seen by viewer.

16. The light device with display means has track-means and removable LED-unit(s), the said display means is bulb lens which are see though clear or opaque milky color or colorful to make the inner preferred Plurality of the said Track-mean(s) and the said LED-unit(s) light can emit to Multiple-directions to areas need the illumination.

17. The light device with display means has track-means and removable LED-unit(s), the said LED bulbs has all track-mean(s) in one extrusion metal piece has multiple surface(s) for track-means(s) and LED-unit(s) installation.

18. The light device with display means has track-means and removable LED-unit(s), the said LED bulbs has certain number of the LED-unit(s) in each of the track means and the number from 1 to N (any number)

19. The light device with display means has track-means and removable LED-unit(s), the said LED bulbs has more than 1 color or brightness or functions or light effects or light performance.

20. The light device with display means has track-means and removable LED-unit(s), the said LED bulbs has wide range for different size and specification of the base which can as normal incandescent bulb's base.

21. The light device with display means has track-means and removable LED-unit(s), the said LED bulb has base which has elastic tip which can allow people to fasten LED bulb more reliable and never over twist the bulb to damage the said LED bulb.

22. The light device with display means has track-means and removable LED-unit(s), the said LED-florescent tube which at least one elongate track-means has more than certain percent length compare with real florescent tube length with other parts & accessories so can fit within all Conventional florescent tube adaptor, base, socket, connect ends.

23. The light device with display means has track-means and removable LED-unit(s), the said LED-florescent tube may has limited angle for the LED-means light beam to be seen by viewer so can save a lot of power for non-necessary illumination area(s) where the real florescent tube can not make this limited area with illumination.

24. The light device with display means has track-means and removable LED-unit(s), the said track-means for LED-florescent tube the track means preferred is extrusion metal single piece with hexagon or octagon design has multiple surface(s) to install desired track-means' related electric parts & accessories for LED-outlets for desire multiple directions has light emit out and to be seen.

25. The light device with display means has track-means and removable LED-unit(s), the said light device at least has one of the said display means apply to the said track-means and LED-unit(s) to make the said Light device look valuable and high cosmetic appearance.

26. The LED light device has geometric art image shown on surface(s), area(s), Floor(s), wall(s) consist of;

At least has one track-mean(s) and removable LED-unit(s) has certain length to fit into device center location to get desired illumination areas, viewing angle, brightness, color, Kelvin temperatures,

At least one circuit means and its related electric parts &

accessories to supply the LED-means trigger current signal under predetermined voltage, current from the power source to circuit means to LED-units to LED-means.

The improvement:

The said Device can change the number of the track-means, removable LED-units, LED-means and also can change the position of the said LED-unit and LED-means to allow people to make its own specification for perfect Device to use indoor or outdoor anywhere people stay.

At least one of display means add to device and the said display means may has desire combination select from block means, stencil, cutouts, opening, masking to make the said LED light beam passing though the light passing medium means, reflective means and travel to the said display means to make a geometric art image on the surface(s), floor, Walls.

27. The LED bulb has incandescent bulb's shape, size, length, diameter , connect ends so can install on all existing incandescent base(s) for variety specifications consist of;

At least has one track-mean(s) and removable LED-unit(s) has certain length to fit into incandescent bulbs' diameter for desired illumination areas, viewing angle, brightness, color, Kelvin temperatures,

At least one circuit means and its related electric parts &

accessories to transfer the existing incandescent bulb's current signal change to the said LED-means trigger current signal under predetermined voltage, current.

The improvement:

The said LED Bulb can change the number of the track-means, removable LED-units, LED-means and also can change the position of the said LED-unit and LED-means to allow people to make its own specification for perfect LED Bulb to use indoor or outdoor anywhere people stay.

28. The LED-Flo-Tube has florescent tube shape, size, length, diameter, connect ends so can install on all existing florescent tube base.

At least has one track-mean(s) and removable LED-unit(s) has certain length to fit into florescent tube's diameter for desired illumination areas, viewing angle, brightness, color, Kelvin temperatures,

At least one circuit means and its related electric parts & accessories to transfer the existing florescent current signal change to the said LED-means trigger current signal under predetermined voltage, current.

The improvement:

The said LED-Flo-Tube can change the number of the track-means, removable LED-units, LED-means and also can change the position of the said LED-unit and LED-means to allow people to make its own specification for perfect LED-Flo-Tube to use indoor or outdoor anywhere people stay.

29. The LED-Flo-Tube has florescent tube shape, size, length, diameter, connect ends so can install on all existing florescent tube base.

At least has one track-mean(s) and removable LED-unit(s) has certain length to fit into florescent tube's diameter for desired illumination areas, viewing angle, brightness, color, Kelvin temperatures,

At least one circuit means and its related electric parts &

accessories to supply the said LED-means trigger current signal under predetermined voltage, current.

The improvement:

The said LED-Flo-Tube can change the number of the track-means, removable LED-units, LED-means and also can change the position of the said LED-unit and LED-means to allow people to make its own specification for perfect LED-Flo-Tube to use indoor or outdoor anywhere people stay.

1. The light device with display means has track-means and removable LED-unit(s) consist of;
At least one track-mean(s) and removable LED-unit(s) has at least one of LED-means to arrange on the said removable LED-unit(s).
The LED-unit(s) has desire light beam output to viewer while the electrodes of the said LED-unit(s) connect to the electric signal though any combination of the resilient conduct means, contact means, conductive means, circuit means, buss means, wire means, adaptor means, transformer means, inverter means, IC means, inductor means, electric parts & accessories, outlet means from the desire power source including Alternative current (AC) or the Direct current (DC) which may come from wall outlets, generator, solar power, batteries, wind power, chemical power or any power form available from conventional market place.
The said LED-unit(s) has removable functions and connect with the buss means all the time while travel within the said track-means by the resilient conductive means.
The said buss-mean supply the electric signal to the electrodes of the said LED-unit(s) from the circuit means, related electric parts & accessories, the said power source so can turn on the said LED-means on the LED-unit(s) for desired light outputs, color, brightness, functions, features, performance.
The said display means the said light device which is a finish product has the display parts & accessories to incorporate the said track-means and removable LED-unit(s) which the display parts & accessories may select from group combination including cover, lens, optics means, reflective lens, diffuser, filter lens, block means, stencil, cutouts, windows, openings, geometric art means, hologram means, lenticular means, 3D film, housing, shade, decorated parts & accessories made by plastic, wood, bamboo, paper, textile, garment, clothing, metal, pottery, ceramic, glass, chemical compound, crystal, mineral material, recycle material with the attachment means, frame means, holder means, fix means, glue means, clipper means, installation means, extendable means, transformer means, foldable means to add such the said display parts & accessories to the said track-means to become finish products has its function including (1) LED Desk Lamp (2) LED Wall lamp (3) LED Floor lamp (4) LED Under cabinet light (5) LED brick light (6) LED step light (7) LED parking light (8) LED light fixture (9) conventional any LED light(s) (10) LED bulb which has at least one of the said track-mean(s) and removable LED-unit(s), (11) LED-florescent tube (12) extendable light bar (13) LED light has geometric art image on surface, floor, walls (14)

2. The light device with display means has track-means and removable LED-unit(s) as claim 1 , the said track-means which has different size to fit into certain space from 1 centimeter (0.4 inch) up to multiple meter (tens of feet).

3. The light device with display means has track-means and removable LED-unit(s) claim 1, the said light device has at least one of the track-means which has at least one of the LED-unit(s) to fit within the said track-means.

4. The light device with display means has track-means and removable LED-unit(s) as claim 1, the said display means has at least partial in front of the said of LED-means or LED-unit(s).

5. The light device with display means has track-means and removable LED-unit(s) claim 1 , the said display means has its geometric size and dimension in x-y-z axis.

6. The light device with display means has track-means and removable LED-unit(s) as claim 1, the said track-mean(s) has positive ratio to the LED-unit(s) means. While bigger track-means(s) will have bigger LED-unit(s) means.

7. The light device with display means has track-means and removable LED-unit(s) as claim 1, the said each track-mean(s) has at least one of LED-unit(s) within the length of the track-mean.

8. The light device with display means has track-means and removable LED-unit(s) as claim 1 , the said LED-unit(s) length and track-mean length can be from 1 to 1,000 to 1 to 0.99 to allow track-means can has at least one LED-unit up to 1,000 piece of LED-units.

9. The light device with display means has track-means and removable LED-unit(s) as claim 1, the said each LED-unit(s) has at least one LED-means up to 1,000 piece of LED-means with proper electric signal to drive the said LED-means for pre-determined functions, effects, performance.

10. The light device with display means has track-means and removable LED-unit(s) as claim 1, the said LED-means is one of specification which can get from conventional market available type.

11. The light device with display means has track-means and removable LED-unit(s) as claim 1, the said LED-unit(s) has desire color assortment, brightness, emit directions, optics means to get desired functions, effects.

12. The light device with display means has track-means and removable LED-unit(s) as claim 1, the said light device has display means to hide the track-means but allow light beam to be seen.

13. The light device with display means has track-means and removable LED-unit(s) as claim 1, the said display means is desire combination select from block means, stencil, cutouts, opening, masking to make the said LED light beam passing though and make a geometric art image on the surface(s), floor, Walls.

14. The light device with display means has track-means and removable LED-unit(s) as claim 1, the said track-means and LED-unit(s) are sealed within the extendable means so can make the light device has total length adjustable from desire maximum length to the shortest length to fit for different space, room, walls distance for illumination.

15. The light device with display means has track-means and removable LED-unit(s) as claim 1, the said geometric art means which consist of the said block means, printing means, stencil means, light passing medium, reflective means to make LED light beam travel within the light passing medium, or at least one or more reflect means to get the geometric art image to be seen by viewer.

16. The light device with display means has track-means and removable LED-unit(s) as claim 1, the said display means is bulb lens which are see though clear or opaque milky color or colorful to make the inner preferred
Plurality of the said Track-mean(s) and the said LED-unit(s) light can emit to
Multiple-directions to areas need the illumination.

17. The light device with display means has track-means and removable LED-unit(s) as claim 1, the said LED bulbs has all track-mean(s) in one extrusion metal piece has multiple surface(s) for track-means(s) and LED-unit(s) installation.

18. The light device with display means has track-means and removable LED-unit(s) as claim 1, the said LED bulbs has certain number of the LED-unit(s) in each of the track means and the number from 1 to N (any number)

19. The light device with display means has track-means and removable LED-unit(s) as claim 1, the said LED bulbs has more than 1 color or brightness or functions or light effects or light performance.

20. The light device with display means has track-means and removable LED-unit(s) as claim 1, the said LED bulbs has wide range for different size and specification of the base which can as normal incandescent bulb's base.

21. The light device with display means has track-means and removable LED-unit(s) as claim 1, the said LED bulb has base which has elastic tip which can allow people to fasten LED bulb more reliable and never over twist the bulb to damage the said LED bulb.

22. The light device with display means has track-means and removable LED-unit(s) as claim 1, the said LED-florescent tube which at least one elongate track-means has more than certain percent length compare with real florescent tube length with other parts & accessories so can fit within all Conventional florescent tube adaptor, base, socket, connect ends.

23. The light device with display means has track-means and removable LED-unit(s) as claim 1, the said LED-florescent tube may has limited angle for the LED-means light beam to be seen by viewer so can save a lot of power for non-necessary illumination area(s) where the real florescent tube can not make this limited area with illumination.

24. The light device with display means has track-means and removable LED-unit(s) as claim 1, the said track-means for LED-florescent tube the track means preferred is extrusion metal single piece with hexagon or octagon design has multiple surface(s) to install desired track-means' related electric parts & accessories for LED-outlets for desire multiple directions has light emit out and to be seen.

25. The light device with display means has track-means and removable LED-unit(s) as claim 1, the said light device at least has one of the said display means apply to the said track-means and LED-unit(s) to make the said Light device look valuable and high cosmetic appearance.

26. The LED light device has geometric art image shown on surface(s), area(s), Floor(s), wall(s) consist of;
At least has one track-mean(s) and removable LED-unit(s) has certain length to fit into device center location to get desired illumination areas, viewing angle, brightness, color, Kelvin temperatures,
At least one circuit means and its related electric parts & accessories to supply the LED-means trigger current signal under predetermined voltage, current from the power source to circuit means to LED-units to LED-means.
The improvement:
The said Device can change the number of the track-means, removable LED-units, LED-means and also can change the position of the said LED-unit and LED-means to allow people to make its own specification for perfect Device to use indoor or outdoor anywhere people stay.
At least one of display means add to device and the said display means may has desire combination select from block means, stencil, cutouts, opening, masking to make the said LED light beam passing though the light passing medium means, reflective means and travel to the said display means to make a geometric art image on the surface(s), floor, Walls.

27. The LED bulb has incandescent bulb's shape, size, length, diameter, connect ends so can install on all existing incandescent base(s) for variety specifications consist of
At least has one track-mean(s) and removable LED-unit(s) has certain length to fit into incandescent bulbs' diameter for desired illumination areas, viewing angle, brightness, color, Kelvin temperatures,
At least one circuit means and its related electric parts &
accessories to transfer the existing incandescent bulb's current signal change to the said LED-means trigger current signal under predetermined voltage, current.
The improvement:
The said LED Bulb can change the number of the track-means, removable LED-units, LED-means and also can change the position of the said LED-unit and LED-means to allow people to make its own specification for perfect LED Bulb to use indoor or outdoor anywhere people stay.

28. The LED-Flo-Tube has florescent tube shape, size, length, diameter, connect ends so can install on all existing florescent tube base.
At least has one track-mean(s) and removable LED-unit(s) has certain length to fit into florescent tube's diameter for desired illumination areas, viewing angle, brightness, color, Kelvin temperatures,
At least one circuit means and its related electric parts &
accessories to transfer the existing florescent current signal change to the said LED-means trigger current signal under predetermined voltage, current.
The improvement:
The said LED-Flo-Tube can change the number of the track-means, removable LED-units, LED-means and also can change the position of the said LED-unit and LED-means to allow people to make its own specification for perfect LED-Flo-Tube to use indoor or outdoor anywhere people stay.

29. The LED-Flo-Tube has florescent tube shape, size, length, diameter, connect ends so can install on all existing florescent tube base.
At least has one track-mean(s) and removable LED-unit(s) has certain length to fit into florescent tube's diameter for desired illumination areas, viewing angle, brightness, color, Kelvin temperatures,
At least one circuit means and its related electric parts &
accessories to supply the said LED-means trigger current signal under predetermined voltage, current.
The improvement:
The said LED-Flo-Tube can change the number of the track-means, removable LED-units, LED-means and also can change the position of the said LED-unit and LED-means to allow people to make its own specification for perfect LED-Flo-Tube to use indoor or outdoor anywhere people stay.
